(19) United States
(12) Patent Application Publication
(10) Pub. No.: US 2026/0091411 A1
(43) Pub. Date: Apr. 2, 2026

(54) DEVICES FOR SORTING TOLERANCE RINGS

(71) Applicant: Toyota Motor Engineering & Manufacturing North America, Inc., Plano, TX (US)

(72) Inventor: Barry J. Ferguson, Barboursville, WV (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/899,241

(22) Filed: Sep. 27, 2024

(51) Int. Cl. B07B 13/18; B07B 13/16

(52) U.S. Cl. CPC B07B 13/18; B07B 13/16

(57) ABSTRACT

A tolerance ring separating apparatus includes a casing having a plurality of surfaces including a first surface, a second surface opposite the first surface, a third surface, and a fourth surface opposite the third surface. The casing has an inlet, and outlet, and an interior cavity formed by the plurality of surfaces. The apparatus also includes a plurality of brushes disposed within the interior cavity, each of the plurality of brushes rotatably coupled to one of a plurality of motors and each of the plurality of motors are coupled to one or more of the plurality of surfaces of the casing. The plurality of brushes are arranged in a first layer including a first brush and a second layer including a second brush and a third brush. The second brush and the third brush rotate in different directions.

### TECHNICAL FIELD

The present specification generally relates to devices for sorting tolerance rings.

### BACKGROUND

Tolerance rings may be thin, radially sprung rings which may be used as a frictional fastener between components. In a manufacturing setting, the tolerance rings may be packaged in containers housing large quantities of tolerance rings. This may tangle the tolerance rings together, which may require an operator to manually untangle tolerance rings to use a single tolerance ring for a given application.

### SUMMARY

In one embodiment, a tolerance ring separating apparatus is provided. The apparatus includes a casing having a plurality of surfaces including a first surface, a second surface opposite the first surface, a third surface, and a fourth surface opposite the third surface. The casing has an inlet, and outlet, and an interior cavity formed by the plurality of surfaces. The apparatus also includes a plurality of brushes disposed within the interior cavity, each of the plurality of brushes rotatably coupled to one of a plurality of motors and each of the plurality of motors are coupled to one or more of the plurality of surfaces of the casing. The plurality of brushes are arranged in a first layer including a first brush and a second layer including a second brush and a third brush. The second brush is configured to rotate in a first direction and the third brush is configured to rotate in a second direction opposite of the first direction.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a device for separating entangled tolerance rings, according to one or more embodiments shown and described herein;

FIG. 2 depicts tangled tolerance rings entering the device for separating tolerance rings;

FIG. 3 depicts an exploded view of the device for separating tolerance rings, according to one or more embodiments shown and described herein; and

FIG. 4 depicts a schematic diagram of the device for separating tolerance rings, according to one or more embodiments shown and described herein.

### DETAILED DESCRIPTION

Devices provided herein separate tangled tolerance rings. Embodiments of the present disclosure may use a series of brushes to automatically detangle the tolerance rings so that a single tolerance ring may be provided to an operator for use in a given application. Various embodiments of devices for separating tangled tolerance rings will be described in more detail herein.

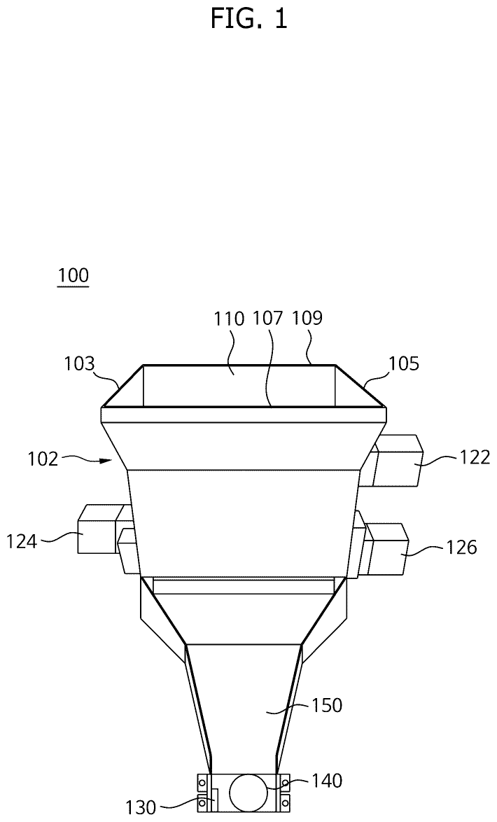

Referring to FIG. 1, a device for separating entangled tolerance rings, according to one or more embodiments shown and described herein. The device 100 may include a casing 102, a motor 122 in an upper layer, motors 124 and 126 in a lower layer, and a camera sensor 130. The casing 102 has a plurality of surfaces including a first surface 103, a second surface 105 opposite the first surface 103, a third surface 107, and a fourth surface 109 opposite the third surface 107. The casing 102 has an inlet 110, and an outlet 150, and an interior cavity formed by the plurality of surfaces 103, 105, 107, and 109.

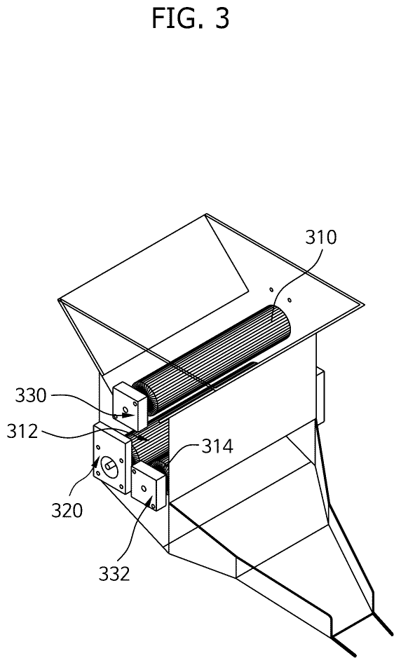

In embodiment, the inlet 110 may include a tapered shape as illustrated in FIGS. 1 and 3. Similarly, the outlet 150 may include a tapered shape as illustrated in FIG. 1. In some embodiments, the inlet 110 and the outlet 150 may have different shapes.

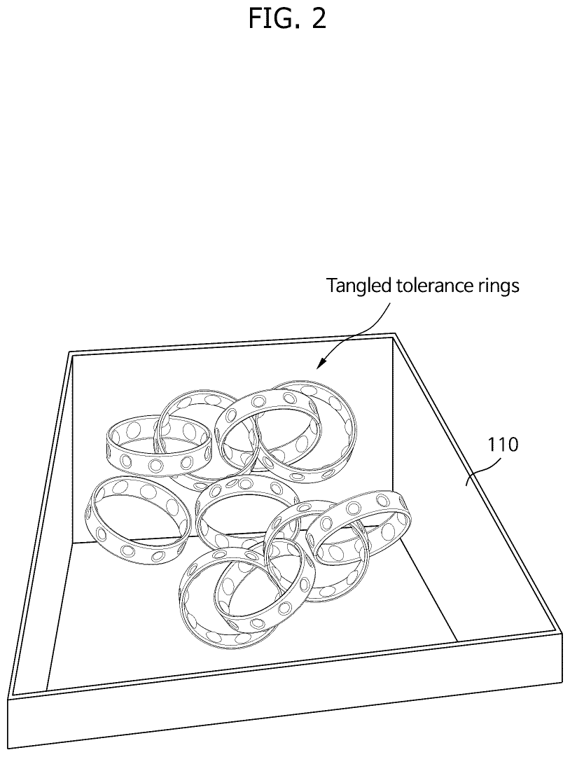

By referring to FIG. 2, tangled tolerance rings may be provided into the inlet 110 of the device. The tangled tolerance rings are untangled in the interior cavity by a plurality of brushes that are connected to the motors 122, 124, and 126, respectively. The plurality of brushes may be brushes 310, 312, and 314 as illustrated in FIG. 3. Each of the motors 122, 124, and 126 may include a stepper motor. In some embodiments, the motors 122, 124, and 126 may be different types of motors including, but not limited to, AC motors, DC motors, servomotors, and the like.

The camera sensor 130 is positioned adjacent to the outlet 150 of the casing 102. The camera sensor 130 is communicatively coupled to a controller of the device 100. The camera sensor 130 captures images and confirms a tolerance ring 140 at the outlet 150.

FIG. 3 depicts an exploded view of the device for separating tolerance rings, according to one or more embodiments shown and described herein.

A plurality of brushes 310, 312, 314 are disposed within the interior cavity of the device 100. Each of the plurality of brushes 310, 312, 314 may include a nylon brush. However, different materials may be used for the brushes.

Each of the plurality of brushes 310, 312, 314 are rotatably coupled to one of the plurality of motors, e.g., motors 122, 124, 126 in FIG. 1. Each of the plurality of motors 122, 124, 126 are coupled to one or more of the plurality of surfaces of the casing 102. For example, by referring to FIGS. 1 and 3, the motors 122 and 126 are coupled to the second surface 105 and the motor 124 is coupled to the first surface 103 which is the opposite of the second surface 105.

The plurality of brushes 310, 312, 314 are arranged in a first layer including the first brush 310 and a second layer including the second brush 312 and the third brush 314. That is, the first brush 310 may be located above the second brush 312 and the third brush 314. In embodiments, the second brush 312 is configured to rotate in a first direction and the third brush 314 is configured to rotate in a second direction opposite of the first direction. For example, the second brush 312 rotates clockwise and the third brush 314 rotates counterclockwise. The first brush 310 and the third brush 314 may be configured to rotate in the same direction.

Each of the motors 122, 124, 126 may be mounted on a motor mount such as a motor mount 320. Specifically, by referring to FIGS. 1 and 3, the motor 124 is mounted on to the motor mount 320 and configured to rotate the second brush 312. While FIG. 3 does not illustrate motor mounts for the motors 122 and 124, the motors 122 and 124 may be mounted on their motor mounts, respectively.

In embodiments, the device 100 may include one or more bearing blocks. Each of the one or more bearing blocks is mounted to one of the plurality of surfaces opposite from one of the plurality of motors. For example, by referring to FIGS. 1 and 3, the bearing block 330 is mounted to the first surface 103 opposite from the motor 122 which is mounted on the second surface 105. Similarly, the bearing block 332 is mounted to the first surface 103 opposite from the motor 126 which is mounted on the second surface 105. Similarly, a bearing block not shown in FIG. 3 is mounted to the second surface 105 opposite from the motor 124.

In embodiments, the second brush 312 and the third brush 314 may be spaced a distance apart equivalent to a thickness of a tolerance ring such that only untangled tolerance rings may be pass through between the second brush 312 and the third brush. In some embodiments, the second brush 312 and the third brush 314 may be spaced a distance apart slightly greater than a thickness of a tolerance ring. For example, the second brush 312 and the third brush 314 may be spaced a distance apart 105% times the thickness of a tolerance ring, 110% times the thickness of a tolerance ring, and the like.

In embodiments, the location of the first brush 310, the second brush 312 or the third brush 314 is adjustable. For example, the distance between the second brush 312 and the third brush 314 may be adjustable. As another example, the height of the first brush 310, the second brush 312 or the third brush 314 may be adjustable.

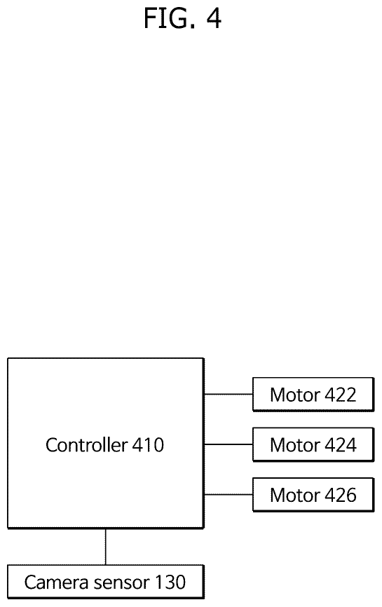

FIG. 4 depicts a schematic diagram of the device for separating tolerance rings, according to one or more embodiments shown and described herein.

The device 100 includes a controller 410. The controller 410 may be any device capable of executing machine readable instructions. For example, the controller 410 may be a processor, an integrated circuit, a microchip, a computer, or any other computing device. The controller 410 is communicatively coupled to other elements, such as the motors 422, 424, 426 and the camera sensor 130. The motors 422, 424, 426 may correspond to the motors 122, 124, 126 in FIG. 1.

The controller 410 may further include one or more memory modules. The one or more memory modules may comprise RAM, ROM, flash memories, hard drives, or any device capable of storing machine readable instructions such that the machine readable instructions can be accessed by one or more processors. The one or more memory modules may be non-transient memory modules. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the one or more memory modules 606. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

The controller 410 may control the operating conditions of the motors 422, 424, 426 such as speeds, torques, durations, and the like. The controller 410 may receive captured images from the camera sensor 130 and process the images using image recognition algorithms.

In embodiments, the controller may process the images to determine whether a tolerance ring is output at the outlet 150. The controller 410 may also process the images to determine whether the output tolerance ring is untangled. If it is determined that the output tolerance ring is untangled, then the controller 410 may maintain the operating conditions of the motors 422, 424, 426 to continue the untangling process. If it is determined that the output tolerance ring is not untangled, then the controller 410 may change the operating conditions of the motors 422, 424, 426. For example, the controller 410 may change the speed or torque of the motors 422, 424, 426. In some embodiments, if it is determined that the output tolerance ring is not untangled, the controller may adjust the locations of the brushes connected to the motors 422, 424, 426.

In some embodiments, the one or more memory modules may store a machine learning model that determines the optimal locations of the first, second, and third brushes 310, 312, 314. For example, the machine learning model may be trained using a training data set that includes the locations of the first, second, and third brushes 310 and information on whether untangled tolerance ring is output. The information on whether untangled tolerance ring is output may include information on the percentage of untangled tolerance rings out of the entire tolerance rings. For example, the lateral distance between the second brush 312 and the third brush 314 may be determined for effectively separating tolerance rings using the trained machine learning model. As another example, the vertical distance between the first brush 310 and the second and third brushes 312 and 314 may be determined for effectively separating tolerance rings using the trained machine learning model. In some embodiments, the training data set may also include the size of a tolerance ring such as a thickness, a diameter, and the like. Then, the controller may determine an optimal lateral distance for effectively separating tolerance rings with the certain sizes using the trained machine learning model.

It should now be understood that the embodiments disclosed herein include a device for separating tangled tolerance rings. The device includes a series of brushes that automatically detangle the tolerance rings. In this regard, a single tolerance ring may be provided to an operator for use in a given application.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

1. A tolerance ring separating apparatus, the apparatus comprising:
a casing having a first surface, a second surface opposite the first surface, a third surface, and a fourth surface opposite the third surface, the casing having an inlet, and outlet, and an interior cavity formed by the first surface, the second surface, the third surface, and the fourth surface; and
a plurality of brushes disposed within the interior cavity, each of the plurality of brushes rotatably coupled to one of a plurality of motors and each of the plurality of motors are coupled to one or more of the first surface, the second surface, the third surface, and the fourth surface of the casing, wherein the plurality of brushes are arranged in a first layer including a first brush and a second layer including a second brush and a third brush, wherein the second brush is configured to rotate in a first direction and the third brush is configured to rotate in a second direction opposite of the first direction.

2. The tolerance ring separating apparatus of claim 1, wherein the second brush and the third brush are spaced a distance apart equivalent to a thickness of a tolerance ring.

3. The tolerance ring separating apparatus of claim 1, wherein a location of the first brush, the second brush or the third brush is adjustable.

4. The tolerance ring separating apparatus of claim 1, further comprising:
a controller, the controller communicatively coupled to one or more of the plurality of motors.

5. The tolerance ring separating apparatus of claim 4, further comprising:
a camera sensor positioned adjacent to the outlet of the casing, the camera sensor communicatively coupled to the controller.

6. The tolerance ring separating apparatus of claim 1, wherein each of the one or more motors comprises a stepper motor.

7. The tolerance ring separating apparatus of claim 1, wherein each of the plurality of brushes comprises a nylon brush.

8. The tolerance ring separating apparatus of claim 1, further comprising:
one or more bearing blocks, each of the one or more bearing blocks mounted to one of the first surface, the second surface, the third surface, or the fourth surface opposite from one of the plurality of motors.

9. The tolerance ring separating apparatus of claim 1, wherein the inlet comprises a tapered shape.

10. The tolerance ring separating apparatus of claim 1, wherein the outlet comprises a tapered shape.

11. The tolerance ring separating apparatus of claim 1, wherein the inlet is formed by the first surface, the second surface, the third surface, and the fourth surface.

12. The tolerance ring separating apparatus of claim 11, wherein the inlet comprises a tapered shape.
